(19) United States
(12) Patent Application Publication
(10) Pub. No.: US 2013/0255658 A1
(43) Pub. Date: Oct. 3, 2013

(54) SEALED INSTRUMENTATION PORT ON CERAMIC COOKTOP

(71) Applicant: Timothy Scott Shaffer, Louisville, KY (US)

(72) Inventor: Timothy Scott Shaffer, Louisville, KY (US)

(21) Appl. No.: 13/434,968

(22) Filed: Mar. 30, 2012

(51) Int. Cl. G01K 7/02; G01K 1/14; F24C 15/10

(52) U.S. Cl. 126/211; 374/208; 374/179; 374/E01.018; 374/E07.004

(57) ABSTRACT

A cooktop for a cooking appliance includes a glass ceramic plate, the glass ceramic plate providing a cooking surface and having an instrumentation opening. A low thermal expansion metallic sleeve is inserted into the opening and a high temperature ceramic cement is used to bond the sleeve to the glass ceramic plate.

### BACKGROUND

The present disclosure generally relates to appliances, and more particularly to an instrumentation port in a surface of a ceramic cooktop.

The use of glass-ceramic plates as cooktops in cooking appliances is well known. In such cooking appliances (referred to herein as glass-ceramic cooktop appliances), a number of heating units are mounted under the glass-ceramic plate. During operation of the cooktop, the glass-ceramic plate is exposed to very high heating temperatures, which results in thermal expansion. The associated stresses can damage the glass-ceramic plate due the brittleness of the glass-ceramic material.

In a cooking appliance such as a range that includes a ceramic cooktop, items that penetrate the ceramic cooktop are separated from contacting the ceramic cooktop with an air gap that accommodates thermal expansion and tolerance stack-up. Typically, current ceramic cooktops do not have any cutouts or ports in zones where intense heat is applied or high temperatures are applied, or there are significant gaps around any penetrating hardware. When an instrumentation sleeve or a sensor is incorporated in a ceramic cooktop in areas where intense heat or high temperatures are applied, the sleeve or sensor is placed in the penetration or cut-out in the ceramic cooktop and is either not sealed or is not flush with the cooktop surface in order to avoid thermal expansion mismatch and associated stress. In zones of relatively cold temperatures elastomeric seals are used to seal the penetrations.

Ceramic glass (such as for example the LAS-System, generally known as Li₂O×Al₂O₃×nSiO₂) has a uniquely low coefficient of thermal expansion of 0.6/° C., which makes it ideal for applications where high thermal gradients are involved. While this low thermal expansion is good for these types of applications, it is fairly limiting for putting other adjacent materials in contact with the ceramic glass in areas where intense heat is applied. In the cooktop application, the local temperatures can approach 600° C., which also limits the available materials that can be used in these zones to metallic and inorganic products.

In cooktop and other similar applications, it is desirable to have sensors such as thermistors, thermocouples, and pressure taps in close proximity to surface of the glass such that the sensors make contact with objects such as cooking utensils that are supported or are themselves in contact with the glass surface. It would be advantageous to be able to hold these sensors securely in place within the glass while minimizing thermal stresses generated by the expansion mismatch of the securing device from the brittle ceramic glass. Accordingly, it would be desirable to provide a penetration or cutout in a ceramic cooktop that addresses at least some of the problems identified above.

### BRIEF DESCRIPTION OF THE INVENTION

As described herein, the exemplary embodiments overcome one or more of the above or other disadvantages known in the art.

One aspect of the exemplary embodiments relates to a sensor assembly. In one embodiment, the sensor assembly includes a glass ceramic plate, the glass ceramic plate including an opening, a sensing device, a metallic sleeve of low thermal expansion that secures the sensing device, the metallic sleeve being disposed in the opening, and a high temperature ceramic cement bonding the metallic sleeve to the glass ceramic plate.

Another aspect of the exemplary embodiments relates to a cooktop for a cooking appliance. In one embodiment, the cooking appliance includes a glass ceramic plate. The glass ceramic plate provides a cooking surface and has an instrumentation opening. A low thermal expansion metallic sleeve is inserted into the opening and a high temperature ceramic cement is used to bond the sleeve to the glass ceramic plate.

A further aspect of the disclosed embodiments is directed to an instrumentation port assembly for a glass ceramic cooktop having a burner disposed under a glass ceramic plate. In one embodiment, the instrumentation port assembly includes a low thermal expansion penetration sleeve disposed in an opening in the glass ceramic plate, a ceramic cement bonding the penetration sleeve to the glass ceramic plate, a sensor disposed in the penetration sleeve for monitoring a condition of the cooktop. A top surface of the penetration sleeve is flush with a top surface of the glass ceramic plate.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and that, unless otherwise indicated, they are merely intended to conceptually illustrate the structures and procedures described herein. In addition, any suitable size, shape or type of elements or materials could be used.

### BRIEF DESCRIPTION OF THE DRAWINGS

In the drawings:

FIG. 1 is a top perspective view of an exemplary appliance incorporating aspects of the present disclosure.

FIG. 2 is a cross-sectional view of a burner section of the glass ceramic cooktop of FIG. 1.

FIGS. 3 and 4 are cross-sectional views of the burner section illustrated in FIG. 1, showing the instrumentation port and sleeve, in a glass ceramic cooktop incorporating aspect of the present disclosure.

### DETAILED DESCRIPTION OF THE EXEMPLARY EMBODIMENTS OF THE DISCLOSURE

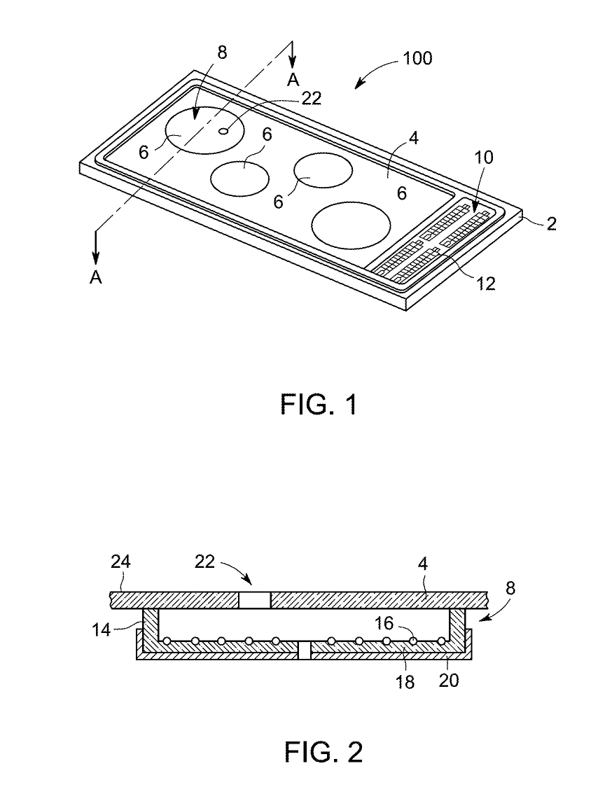

Referring to FIG. 1, an exemplary glass ceramic cooking appliance incorporating aspects of the disclosed embodiments is generally designated by reference numeral 100. The aspects of the disclosed embodiments are generally directed to a penetration port or sleeve through a glass ceramic cooktop that eliminates thermal expansion mismatch and associated stress, yet is still capable of high temperature service. Although the embodiments disclosed will be described with reference to the drawings, it should be understood that the embodiments disclosed can be embodied in many alternate forms. In addition, any suitable size, shape or type of elements or materials could be used. In the examples described herein, the glass ceramic cooking appliance 100 is configured as a free standing range. However, it should be understood that the aspects of the exemplary embodiments may be applied to any suitable glass ceramic cooking appliance.

As shown in FIG. 1, the glass-ceramic cooking appliance 100 generally includes an outer body or cabinet 2, also referred to as a frame, that incorporates a substantially rectangular glass-ceramic plate 4, referred to herein as “cooktop 4”, that provides a cooking surface. Cooktop 4 is configured to withstand temperatures that can reach in excess of 600 degrees Centigrade in areas proximate the heating elements. In this example, the glass-ceramic cooking appliance 100 of FIG. 1 is in the form of an electrically powered built-in cooktop appliance. In alternate embodiments, the glass-ceramic cooking appliance 100 may be any suitable cooking appliance, including a range with a glass ceramic cooking surface provided thereon or other combinations of induction/electric and gas/electric cooking appliances.

In the example shown in FIG. 1, circular patterns 6 formed on the cooking surface of the cooktop 4 generally identify the positions of each of a number of burner assemblies 8 that are positioned in a spaced apart relationship underneath the cooktop 4. By virtue of their proximity to the heating elements of the burner assemblies 8 these patterns 6 also represent high temperature areas of the cooktop 4 which can reach temperatures on the order of 600 degrees Centigrade when the associated heating element is operating at full power. Although four patterns 6 are shown in FIG. 1, in alternate embodiments, the cooktop 4 can include any number of patterns 6 and respective burner assemblies 8.

As is shown in FIG. 1. the glass-ceramic cooking appliance 100 can also include a control panel 10. The control panel 10 can include one or more control devices, such as touch pad arrays 12, which can be used to control the various operating functions and modes of the appliance 100, including example, individual control of the temperature of the burner assemblies 8. Although the control devices are generally described herein as touchpads, it will be understood that any suitable control device can be utilized, including for example, switches, slides, rotary knobs, touch screens, or other suitable electronic or electro-mechanical controls.

FIG. 2 illustrates an exemplary burner assembly 8 located below the cooktop 4 so as to heat a utensil placed thereon. In this example, the burner assembly 8 includes a controllable energy source 16 in the form of an open coil resistance element. Each burner assembly 8 is located in a desired position relative to the underside of the cooktop 4. The energy source 16 is arranged in an effective heating pattern such as a concentric coil and is secured to a burner casing 18 that is supported in a sheet metal support pan 20. In this embodiment, the burner casing 18, also referred to as an insulating liner, includes an upwardly extending portion 14 which serves as an insulating spacer between the coil element 16 and the glass ceramic cooktop 4. The burner casing 18 is made from a thermally insulating material, such as ceramic. The ceramic cooktop 4 includes an opening 22 therein. The opening 22 serves as a penetration or instrumentation port to enable a sealed penetration of a high temperature area of cooktop 4 with compatible low thermal expansion materials. The opening 22 can accommodate glass or instrumentation hardware, which can be used to monitor cooktop conditions. For example, one application can include direct measurements of the temperature of a utensil on the cooktop 4, using a sensor that is integral with the cooktop 4, as well as flush with a top surface 24 of the cooktop 4.

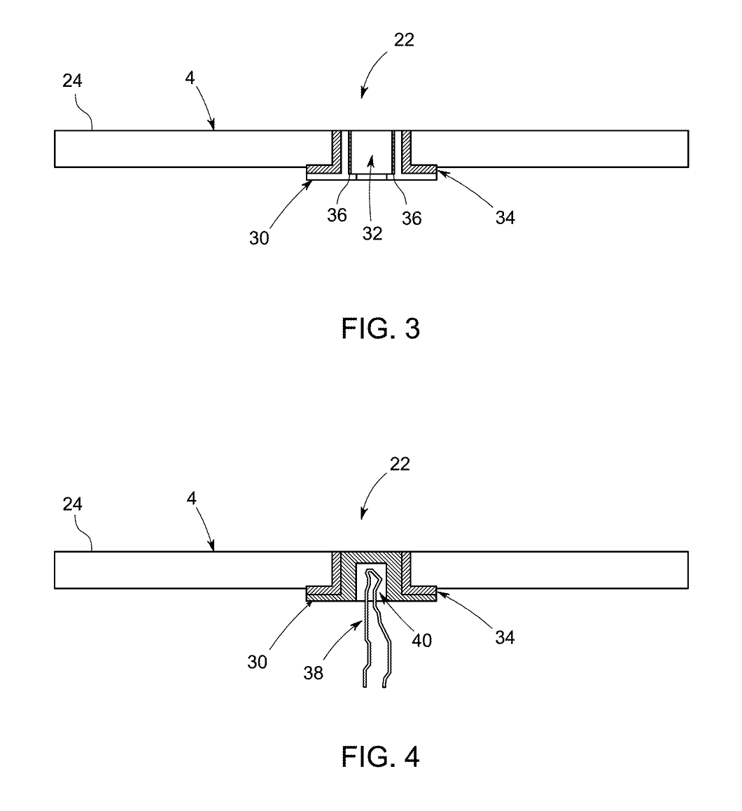

FIG. 3 illustrates a partial cross-sectional view of the ceramic glass cooktop 4 shown in FIG. 1 taken along the line A-A. In this embodiment, a penetration sleeve 30 is provided in the opening 22 therein in accordance with the aspects of the present disclosure. The penetration sleeve 30 enables sealed penetration of a high temperature area of the cooktop 4. The sleeve 30 can be made in various configurations to accept glass or other instrumentation hardware. The sleeve 30 allows for electrical and mechanical connections above and below the cooktop 4. In the example shown in FIG. 3, the penetration sleeve 30 is flush with the top surface 24 of the cooktop 4.

In one embodiment, the penetration sleeve 30 is a metallic sleeve. The metallic sleeve 30 is fabricated from a material that has a low coefficient of thermal expansion which closely approaches that of the ceramic glass, so that the thermal expansion of the sleeve approximates that of the ceramic glass. A material with a low coefficient of thermal expansion, as that term is used herein, generally includes any material that has a coefficient of thermal expansion less than or equal to 1 microstrain per degree Kelvin (≦1 μin/in °K.). This minimizes the stress that can accumulate as the temperatures of the ceramic glass cooktop 4 are elevated during operation of the appliance 100. The material of the metallic sleeve 30 will have a low coefficient of thermal expansion and be able to survive temperatures above approximately 175 degrees Centigrade (350 degrees Fahrenheit). As is noted, regions of the ceramic glass cooktop 4 proximate the heating elements are high temperature areas that can be exposed to temperatures that can reach in excess of 600 degrees Centigrade. The aspects of the disclosed embodiment provide a sealed, flush penetration that can be applied through the ceramic glass cooktop 4 in the regions that are exposed to such high temperatures.

In one embodiment, the sleeve 30 is bonded to the cooktop 4 with a high temperature ceramic cement 34. The cement 34 can comprise a mica-silica mix with a conventional solvent binder. Many of these cements have higher thermal expansions than the glass, but the thinness of the adhesive layer makes its contribution to thermal expansion stress insignificant. One example of such a cement 34 is Aremco Ceramabond 552. In one embodiment, a thickness of the layer of cement 34 is in the range of approximately 0.001 to and including 0.002 inches.

Preferably, the metallic sleeve 30 is fabricated from a nickel alloy, such as an Invar alloy. Invar is generally understood to be a nickel alloy with exceptionally low thermal expansion. In one embodiment, the Invar alloy is INVAR 36, for example. Invar is generally 64% Iron and 36% Nickel. The thermal expansion of the metal at approximately 1×10−6/° C. is essentially the same as that of the ceramic glass. It provides a machinable, malleable substance for holding the sensor, bonding into the glass via through-penetrations and then handling temperatures up to 600° C. without damaging the ceramic glass.

Depending upon the application and what information is desired to be monitored on or above the cooktop 4, the sleeve 30 can be internally potted or filled with a ceramic cement. In the embodiment shown in FIG. 3, a germanium or fused silica glass plug 32 is fitted in the penetration sleeve 30 and sealed with ceramic cement 36. In one embodiment, the plug 32 is used as a light filter to isolate the infrared wavelength range of heat from the bottom of the cooking utensil, such as a pan or pot. The cement 36 is typically used around the sides of the plug 36, but not on the bottom or top.

Referring to FIG. 4, an embodiment is illustrated where a thermocouple 38 is potted into the sleeve 30 using cement 40. The cement 40, which is similar to the cement 34 shown in FIG. 3, is used to pot the thermocouple 38 in place in the sleeve 30. This same basic approach can be applied for other electrical connections and other types of sensors. The sleeve 30 will act to absorb the thermal expansion of the internal components and isolate that expansion away from the ceramic glass of the cooktop 4, which can tend to be brittle and limited in elastic deformation tolerance.

The exemplary embodiments described herein provide a penetration sleeve through a ceramic cooktop that enables a sealed penetration of a high temperature area of the cooktop, with compatible low thermal expansion materials. The sleeve can be made in various configurations to accept glass or instrumentation hardware which can be used to monitor cooktop conditions. The sleeve is bonded to the ceramic glass cooktop with a high temperature ceramic cement. The sealed penetration is configured to be flush with the top surface of the cooktop and allows for electrical and mechanical connections above and below the cooktop. The metallic sleeve can be fabricated from Invar and the cement can be a mica-silica mix.

Thus, while there have been shown and described and pointed out fundamental novel features of the invention as applied to the exemplary embodiments thereof, it will be understood that various omissions and substitutions and changes in the form and details of devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A sensor assembly comprising:
a glass ceramic plate, the glass ceramic plate comprising an opening;
a sensing device;
a metallic sleeve of low thermal expansion that secures the sensing device, the metallic sleeve being disposed in the opening; and
a high temperature ceramic cement bonding the metallic sleeve to the glass ceramic plate.

2. The sensor assembly of claim 1, wherein the metallic sleeve is substantially flush with a top surface of the glass ceramic plate and hermetically sealed with the glass ceramic plate.

3. The sensor assembly of claim 1, wherein the metallic sleeve comprises an Invar alloy.

4. The sensor assembly of claim 1, wherein the high temperature ceramic cement comprises a mica-silica mix.

5. The sensor assembly of claim 1, wherein the sensor comprises a thermocouple.

6. A cooktop for a cooking appliance, comprising:
a glass ceramic plate, the glass ceramic plate providing a cooking surface and comprising an instrumentation opening:
a low thermal expansion metallic sleeve inserted into the opening; and
a high temperature ceramic cement bonding the metallic sleeve to the glass ceramic plate.

7. The cooktop of claim 6, wherein the sleeve comprises a nickel alloy.

8. The cooktop of claim 7, wherein the nickel alloy sleeve comprises an Invar alloy.

9. The cooktop of claim 6, wherein the cement comprises a mica-silica mix.

10. The cooktop of claim 6, wherein the sleeve is internally potted with a ceramic cement.

11. The cooktop of claim 10, further comprising a thermocouple potted in the sleeve.

12. The cooktop of claim 6, wherein the glass ceramic plate comprises a top surface and a bottom surface, a top surface of the sleeve being flush with the top surface of the glass ceramic plate.

13. The cooktop of claim 12, further comprising a sensor in the sleeve, the sensor being flush with the top surface of the glass ceramic plate and configured to substantially contact a utensil on the cooking surface.

14. The cooktop of claim 12, wherein the metallic sleeve is hermetically sealed with the glass ceramic plate.

15. An instrumentation port assembly for a glass ceramic cooktop comprising a burner disposed under a glass ceramic plate, the instrumentation port assembly comprising:
a low thermal expansion metallic penetration sleeve disposed in an opening in the glass ceramic plate;
a ceramic cement bonding the metallic penetration sleeve to the glass ceramic plate;
a sensor disposed in the metallic penetration sleeve for monitoring a condition of the cooktop; and
wherein a top surface of the metallic penetration sleeve is flush with a top surface of the glass ceramic plate.

16. The instrumentation port assembly of claim 15, wherein the metallic sleeve comprises a nickel alloy.

17. The instrumentation port assembly of claim 15, wherein the nickel alloy sleeve comprises an Invar alloy.

18. The instrumentation port assembly of claim 15, wherein the cement comprises a mica-silica mix.

19. The instrumentation port assembly of claim 15, wherein the sleeve is internally potted with a ceramic cement.

20. The instrumentation port assembly of claim 19, further comprising a thermocouple potted in the sleeve.
